(19) United States
(12) Patent Application Publication
(10) Pub. No.: US 2012/0224054 A1
(43) Pub. Date: Sep. 6, 2012

(54) Optical Position Detecting Device

(75) Inventor: Yasuji Ogawa, Kita-Katsushika-gun (JP)

(73) Assignee: NC3 INC, Ibaraki (JP)

(21) Appl. No.: 13/386,392

(22) PCT Filed: Jul. 14, 2010
(86) PCT No.: PCT/JP2010/004575

§ 371 Date: May 10, 2012

Related U.S. Application Data
(60) Provisional application No. 61/227,604, filed on Jul. 22, 2009.

(30) Foreign Application Priority Data
Jul. 22, 2009 (JP) 2009-171582

(51) Int. Cl. H04N 7/18

(52) U.S. Cl. 348/135; 348/E07.085

(57) ABSTRACT

The optical position detecting device includes a plurality of light source sections, a camera section, a detection section and a control section. Each of the plurality of light source sections emits light to irradiate a predetermined region of the detection surface. The camera section has an angle of view capable of imaging the entire surface of the detection surface and images an image the indicator body irradiated by the light source sections. The detection section calculates an indicated position of the indicator body. The control section is adapted to turn on the plurality of light source sections simultaneously or in a predetermined sequence at time of initial scan and, once the indicated position of the indicator body is detected by the detection section, turns on the light source section irradiating a range covering the detected indicated position of the indicator body but turns off all the remaining light source sections.

### CROSS REFERENCE TO RELATED APPLICATION

This is a 35 U.S.C. §371 application of, and claims priority to, International Application No. PCT/JP2010/004575, which was filed on Jul. 14, 2010 and published in English as Publication No. WO 2011/010441, which claims priority to Japanese Patent Application No. 2009-171582, which was file on Jul. 22, 2009, and which claims priority to U.S. Provisional Patent application No. 61/227,604 filed on Jul. 22, 2009, the entirety of all application are incorporated herein by reference.

### TECHNICAL FIELD

The present invention relates to an optical position detecting device and, more particularly to an optical position detecting device that can quickly detect an indicator body with low power consumption.

### BACKGROUND ART

Optical position detecting devices using LEDs or the like as a light source for detecting an indicated position of an indicator body have been known. For example, Patent Document 1 by the same inventor of the present application describes an optical position detecting device intended to achieve low power consumption and low cost by reducing the number of light sources. The device includes retroreflective members arranged at three sides of a detection surface and two imaging units for picking up an image of the shadow of an indicator body. The imaging units have a camera section and a light source. The light source is arranged near one of the right and left sides of the camera section in a horizontal direction. It is described that the number of light sources to be used for an imaging unit can be reduced to one to achieve low power consumption rate and low cost.

### CITATION LIST

### Patent Literature

Patent Document 1: Japanese Patent Application Kokai Publication No. 2005-107607

### SUMMARY OF INVENTION

### Technical Problem

However, when the detection surface is large, it has been difficult to irradiate light so as to cover the entire detection surface when a single light source is employed. When a single LED is employed, it needs to be powerful to a certain extent in order to irradiate a wide range by the single LED to make it impossible to achieve low power consumption and low cost.

Additionally, while a light source that can irradiate light stronger than ambient light is preferably employed in order to eliminate the influence of ambient light arriving from other than the light source of the imaging unit, there are occasions where an LED or the like that can irradiate strong light involves high power consumption and high cost. Another method of eliminating the influence of ambient light is to use an infrared LED as a light source and image an indicator body, employing an infrared transmitting filter at the camera section. However, with such an arrangement, a light source that can irradiate strong light to a certain extent needs to be used when the loss in the quantity of light due to the use of the infrared transmitting filter is taken into consideration.

Furthermore, high-speed imaging of about 60 frames per second is required to improve the detection sensitivity for an indicator body and detect the indicator body, following up a high-speed movement thereof. However, when the imaging speed is raised, the shutter speed is raised accordingly and hence a greater quantity of light is required. Thus, in such an occasion, it has been difficult to realize low power consumption for a light source.

When an optical position detecting device is applied to a digitizer to be connected to a computer, for example, a USB is more often than not employed for the connection. Then, if it is so arranged that power source is supplied by means of USB bus power, there is a limitation that the consumption current by USB bus power is maximally 500 mA. Therefore, there can be occasions where the highest consumption current is exceeded when power source is supplied to a digitizer that uses a strong light source by means of USB bus power. Thus it is difficult to supply power source by means of USB bus power.

In view of the above-described circumstances, the present invention provides an optical position detecting device that can detect an indicator body with high accuracy and high speed under low power consumption.

### Means for Solving the Problems

To achieve the above-described object of the present invention, an optical position detecting device according to the present invention may include: a plurality of light source sections each for emitting light to irradiate a predetermined region of the detection surface so as to be able to selectively irradiate the entire surface of the detection surface by combination thereof; a camera section having an angle of view capable of imaging the entire surface of the detection surface, and imaging an image of the indicator body irradiated by the light source sections; a detection section for calculating an indicated position of the indicator body by using the image of the indicator body imaged by the camera section; and a control section adapted to turn on the plurality of light source sections simultaneously or in a predetermined sequence at time of initial scan and, once the indicated position of the indicator body is detected by the detection section, turning on at least one of the light source sections irradiating a range covering the indicated position of the indicator body detected but turning off or reducing power for lighting all the remaining light source sections.

Each of the plurality of light source sections may emit light for irradiating a strip-shaped region in the direction to the detection surface.

Each of the plurality of light source sections may emit light for irradiating a fan-shaped region in the direction to the detection surface.

Each of the plurality of light source sections may emit light for irradiating a square-shaped region in the direction to the detection surface.

Each of the plurality of light source sections may emit light for irradiating a circle-shaped region in the direction to the detection surface.

Each of the plurality of light source sections may have a beam forming lens and an LED.

Each of the plurality of light source sections may have a cylindrical lens and an LED.

The detection surface may transmit light and each of the plurality of light source sections may have a light guide plate arranged at a rear surface side of the detection surface and an LED.

The detection surface may transmit light and the plurality of light source sections may have a diffusion plate arranged at a rear surface side of the detection surface and a plurality of LEDs.

Each of the plurality of light source sections may be arranged at a position separated from the detection surface in a vertical direction relative to a front surface side of the detection surface.

The detection surface may transmit light and each of the plurality of light source sections may be arranged at a position separated from the detection surface in a vertical direction relative to a rear surface side of the detection surface.

Each of the plurality of light source sections may have an infrared LED and the camera section may have an infrared transmitting filter.

The control section may control so as to make the irradiation power of each of the light source sections irradiating a range covering the indicated position of the indicator body stronger than the irradiation power of each of the light source sections when turning on the light source sections simultaneously or in a predetermined sequence at the time of the initial scan.

The camera section may image the entire surface of the detection surface from a position separated from the detection surface in a vertical direction relative to a front surface side of the detection surface.

The detection surface may transmit light and the camera section may image the entire surface of the detection surface from a position separated from the detection surface in a vertical direction relative to a rear surface side of the detection surface.

The camera section may have a windowing function of imaging the region of a window defined at an arbitrary place to an arbitrary size in the angle of view capable of imaging.

The detection section may detect an image of the indicator body by using a separability filter.

The optical position detecting device may further include a display device, a display surface of the display device being the detection surface.

The display surface of the display device may be made of a light transmitting material and the light source sections may be arranged at a rear surface side of the display surface.

### Advantageous Effects of Invention

An optical position detecting device according to the present invention provides advantages of achieving low power consumption and being capable of detecting the indicated position of an indicator body with high accuracy and high speed.

### BRIEF DESCRIPTION OF DRAWINGS

FIG. 1 is a schematic configuration view for illustrating a first embodiment of an optical position detecting device according to the present invention.

FIG. 2 is a schematic configuration view for illustrating a second embodiment of an optical position detecting device according to the present invention.

FIG. 3 is a schematic configuration view for illustrating a third embodiment of an optical position detecting device according to the present invention.

FIG. 4 is a schematic configuration view for illustrating a fourth embodiment of an optical position detecting device according to the present invention.

FIG. 5 is a schematic configuration view for illustrating a fifth embodiment of an optical position detecting device according to the present invention.

FIG. 6 is a schematic plan view for illustrating a window function of a camera section of an optical position detecting device according to the present invention.

### DESCRIPTION OF EMBODIMENTS

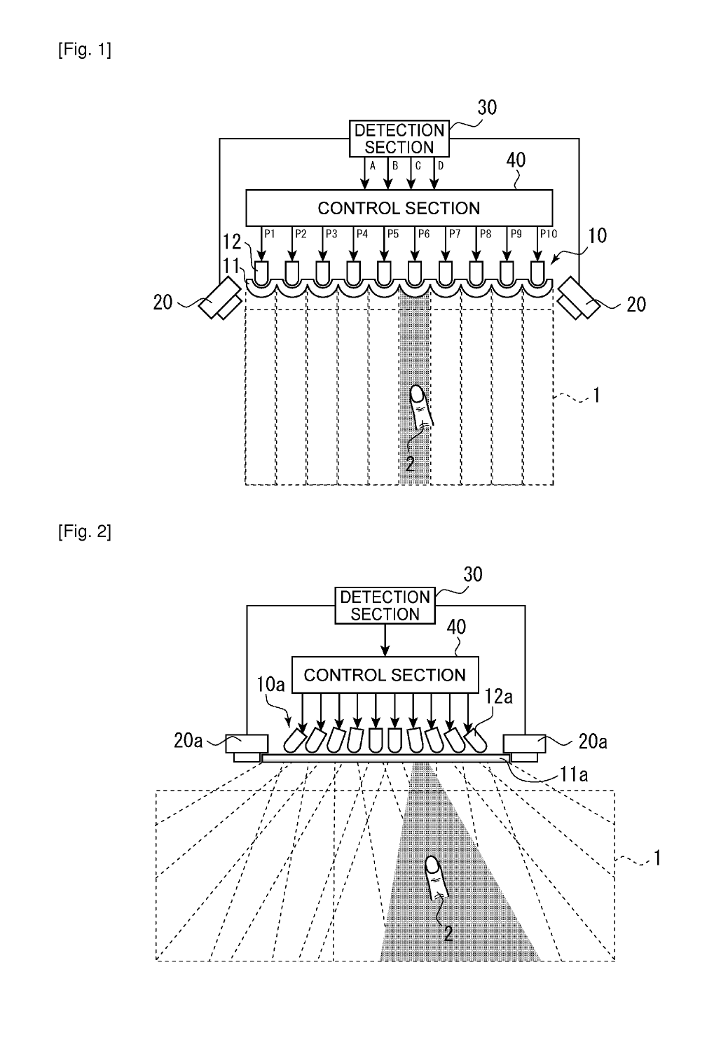

A preferred embodiment for practicing the present invention will be described below with reference to the accompanying drawings. FIG. 1 is a schematic configuration view for illustrating a first embodiment of an optical position detecting device according to the present invention. As illustrated, the optical position detecting device according to the present invention is for detecting an indicated position of an indicator body 2 input to a detection surface 1 and mainly includes light source sections 10, a camera section 20, a detection section 30 and a control section 40.

The light source is formed by a plurality of light source sections 10 for irradiating predetermined regions of the detection surface 1 so as to be able to selectively irradiate the entire surface of the detection surface by combining them. While the light source is formed by ten light source sections in the illustrated example, the present invention is not limited to this but an arbitrary number may be selected according to the size of the detection surface 1 and the irradiating region of each of the light source sections 10. The light source sections 10 of the illustrated example are so formed as to emit light that irradiates a strip-shaped region in the direction of the detection surface. More specifically, each light source section 10 includes a beam forming lens 11 and an LED 12. The beam forming lens 11 is a lens having a concave surface and a convex surface and refracts (converges) light from the LED 12 in such a way that each light emitted from the LED 12 is turned into substantially parallel strip-shaped light in a horizontal direction with each other and also refracts (converges) light in such a way that each light emitted from the LED 12 is made substantially parallel relative to the detection surface 1 in the vertical direction. In other words, the light source sections 10 can irradiate light that is parallel to the detection surface 1 and that is strip-shaped light in the direction of the detection surface. The refraction surface and the curvature of the beam forming lens 11 may be determined such that light is made to run along the direction of the detection surface and such that the plurality of light source sections 10 can cover the entire surface with the strip-shaped light. The beam forming lens 11 may be made of resin for lenses, for example. Resin for lenses may be plastic such as acryl and polycarbonate. No polishing process is required so that the lenses can be manufactured at low cost when the lenses are formed by molding resin for lenses. In the illustrated example, the beam forming lens 11 for the plurality of light source sections 10 is integrally molded.

The camera section 20 has an angle of view that can image the entire surface of the detection surface and images the indicator body 2 irradiated by the light source sections 10. In the illustrated example, two camera sections 20 are arranged respectively at left and right corners of the detection surface 1. Each of the camera sections 20 has an angle of view that can image the entire surface of the detection surface. More specifically, each of the camera sections 20 has a line of sight that is parallel to the detection surface 1 and a field of view spreading in the direction of the detection surface so as to be able to detect the indicator body 2 input onto the detection surface 1 in a direction of view that is parallel to the detection surface 1. The camera section 20 includes, for example, a lens and an image sensor. The lens has an angle of view that can image the entire surface of the detection surface. For example, the lens is a wide angle lens having a wide horizontal angle of view and arranged so as to have a line of sight that is parallel to the detection surface 1 and a field of view spreading in the direction of the detection surface 1. The wide angle lens may be made of resin for lenses. The image sensor is a solid state imaging device such as CCD or CMOS. The image sensor may be a linear image sensor or an area image sensor. In the case of the area image sensor, the advanced detection can be achieved because the sensor can detect a move of the indicator body in the height direction before and after the detection of a touch of the indicator body to the detection surface.

The camera section 20 to be used for the optical position detecting device according to the present invention is not limited to this but any other camera section having an angle of view that can image the entire surface of the detection surface and capable of imaging the indicator body 2 irradiated by the light source sections 10 may alternatively be employed. For example, any lenses may be used so long as the lens arrangement provides an angle of view that can entirely cover the direction of the detection surface.

The LEDs of the light source sections 10 may be infrared LEDs and the camera section 20 may include an infrared transmitting filter in order to prevent any erroneous recognition of the indicator body from the influence of ambient light. Alternatively, light from the light source sections may be pulsed light and the camera section may image with pulsed light.

The detection section 30 calculates the indicated position of the indicator body 2, using the images of the indicator body 2 imaged by the camera sections 20. The detection section 30 calculates the indicated position (the two-dimensional coordinates) of the indicator body 2 on the principle of triangulation by using the positions of the images of the indicator body 2 imaged by each of the camera sections and using the distance between the two camera sections 20. When no indicator body 2 is input onto (placed on) the detection surface 1, no indicator body is imaged by the camera sections 20. As the indicator body 2 is input onto (placed on) the detection surface 1, the indicator body 2 that is irradiated by the light source sections 10 is imaged by the camera sections 20. Therefore, the coordinates of the indicated position on the detection surface 1 can be calculated on the principle of triangulation by using the positions of the two images.

The detection of the indicator body 2 may be carried out by the detection section 30 by means of pattern recognition using, for example, the images of the indicator body 20 imaged by the camera sections 20. A separability filter may be employed for the detection of the indicator body 2 by the pattern recognition. The separability filter is for measuring the degree of closeness of the distribution of shading values in a narrow range to a double annular figure and an image can be recognized as that of the indicator body when the separability is not less than a predetermined threshold value. An indicator body can be detected stably by using the separability filter to eliminate ambient light and confusing images.

One of the particular characteristics of the optical position detecting device according to the present invention is that it has the control section for controlling the device having the above-described configuration in a manner as described below. The control section 40 controls the plurality of light source sections 10 so as to turn them on simultaneously or in a predetermined sequence at the time of the initial scan. The initial scan as used herein refers to a scan period until the indicator body 2 is detected. When the plurality of light source sections 10 are turned on simultaneously, the current consumption can exceed a prescribed value. Therefore, the light source sections 10 may be so controlled as to reduce the power for turning on the individual light source sections 10 and confine the total current consumption to less than a prescribed value. In the case where the light source sections 10 are turned on in a predetermined sequence, they may be turned on sequentially from an end or randomly.

Once the indicated position of the indicator body 2 is detected by the detection section 30, the control section 40 so controls as to turn on the light source section 10 that irradiates the range covering the indicated position of the indicator body 2 (the shaded part in FIG. 1) and turn off the remaining light source sections 10 or reduce the power being used for keeping the remaining light source sections 10 being lighted. It is also possible to differentiate the quantity of emitted light of each of the light source sections 10 at the time of the initial scan and the quantity of emitted light for irradiating the range covering the detected indicated position of the indicator body. In other words, the control section so controls as to make the irradiation power of the light source section irradiating the range covering the indicated position of the indicator body stronger than the irradiation power of each of the light source sections when the light source sections are turned on simultaneously or in a predetermined sequence at the time of the initial scan. As a result, it is possible to intensify the irradiation power to improve the detection sensitivity at the time of imaging the indicator body, while reducing the current consumption at the time of the initial scan.

In a case where the indicator body 2 is moving, it is possible to follow the move of the indicator body and keep on detecting the indicated position of the indicator body. In such a case, the control section 40 operates for feedback control so as to follow the move of the indicator body and keep on irradiating the indicator body 2, while switching the light source sections 10 irradiating the indicator body 2 so as to turn off the light source sections 10 other than the one irradiating the indicator body 2. In other words, the light source section 10 irradiating the position of the indicator body 2 by using the coordinates of the indicated position of the indicator body 2 detected by the detection section 30 is determined and turns it on but keeps all the remaining light source sections 10 being unlighted. However, if the coordinates of the detected indicated position change, it repeats an operation of newly determining the light source section 10 irradiating the position accordingly and turning it on but turning off all the remaining light source sections 10.

With such a control operation, the number of light source sections 10 that are turned on to irradiate the indicator body 2 is minimized to make it possible to minimize the current consumption. Since it is sufficient to turn on at least one of the light source sections 10, it is also possible to emit very strong light so that a sufficient quantity of light can be secured at the time of high-speed imaging where the shutter speed is short. Therefore, it is possible to detect with high-accuracy an indicator body that is moving at high speed, while keeping low power consumption.

At the time of the initial scan, there may be occasions where a sufficient quantity of light is not secured for imaging the indicator body 2 due to the relationship between the shutter speed and the exposure time and/or in view of power consumption. However, it is also possible to control in such a way that the indicator body 2 is detected only roughly at the time of the initial scan and only the light source section 10 irradiating the indicator body 2 is turned on when the indicator body 2 is confirmed to a certain extent in order to detect the accurate image of the indicator body 2. The light source sections other than the one irradiating the indicator body may be turned off when the indicator body is detected. However, the light source sections are constantly in a standby status for detecting the indicator body 2 on the detection surface if the power for keeping them being turned on is reduced under control so that, if another indicator body is newly input, it can be detected immediately without performing any initial scan.

The detection section 30 and the control section 40 can be realized by using an electronic computer such as a microprocessor or a personal computer. A control signal is input to the control section 40 and a lighting signal is output to the plurality of light source sections 10 from the control section 40. Now, the control signal will be described below in detail. For example, the table shown below is used to control so as to turn on three consecutive light source sections simultaneously by means of a 4-bit control signal for 10 light source sections. Note that ABCD and P1 to P10 correspond to the control signal and the output signal (lighting signal) of the control section 40 in FIG. 1.

TABLE 1

| Control signal | | | | Lighting signal (1 for lighting, 0 for unlighting) | | | | | | | | | |
|---|---|---|---|---|---|---|---|---|---|---|---|---|---|
| A | B | C | D | P1 | P2 | P3 | P4 | P5 | P6 | P7 | P8 | P9 | P10 |
| 0 | 0 | 0 | 0 | 0 | 0 | 0 | 0 | 0 | 0 | 0 | 0 | 0 | 0 |
| 0 | 0 | 0 | 1 | 1 | 1 | 1 | 0 | 0 | 0 | 0 | 0 | 0 | 0 |
| 0 | 0 | 1 | 0 | 0 | 1 | 1 | 1 | 0 | 0 | 0 | 0 | 0 | 0 |
| 0 | 0 | 1 | 1 | 0 | 0 | 1 | 1 | 1 | 0 | 0 | 0 | 0 | 0 |
| 0 | 1 | 0 | 0 | 0 | 0 | 0 | 1 | 1 | 1 | 0 | 0 | 0 | 0 |
| 0 | 1 | 0 | 1 | 0 | 0 | 0 | 0 | 1 | 1 | 1 | 0 | 0 | 0 |
| 0 | 1 | 1 | 0 | 0 | 0 | 0 | 0 | 0 | 1 | 1 | 1 | 0 | 0 |
| 0 | 1 | 1 | 1 | 0 | 0 | 0 | 0 | 0 | 0 | 1 | 1 | 1 | 0 |
| 1 | 0 | 0 | 0 | 0 | 0 | 0 | 0 | 0 | 0 | 0 | 1 | 1 | 1 |

At the time of the initial scan, all the patterns of the control signal ABCD in Table 1 above are input to scan the entire surface of the detection surface. As the indicator body 2 is detected during the scan, information on the indicated position of the indicator body 2 is sent from the detection section 30 to the control section 40. For example, in the case where the indicated position coordinates are found in the range irradiated by the light source section 10 to which the lighting signal of P5 is input, the control signal ABCD will be 0100 to turn on three consecutive light source sections 10 centered at the light source section 10 that corresponds to P5. If the indicator body 2 moves and, more specifically, moves into the range irradiated by the light source section 10 that corresponds to P6, the control signal ABCD will be 0101 to turn on three consecutive light source sections 10 centered at the light source section 10 that corresponds to P6. When three consecutive light source sections are turned on simultaneously in this way, the indicator body that moves at high speed can be continuously irradiated because the range (width) that is irradiated to irradiate the indicator body is broad if compared an example where a single light source section is lighted. When the indicator body is no longer detected, it may be so controlled that the control signal ABCD is turned to the initial state of 0000 to scan the entire surface of the detection surface anew. Note that the control signal and the number of bits are not limited to these so long as the light source sections can be controlled in a manner intended by the invention of the present patent application.

The optical position detecting device according to the present invention may be formed as a touch panel display where the display surface of the display apparatus is made to operate as the detection surface. For example, the display surface of a liquid crystal display may be made to operate as the detection surface and the light source sections of the position detecting device of the present invention may be arranged near the back light of the liquid crystal display. Furthermore, the display surface of a display apparatus such as a liquid crystal display, an organic EL display or an electronic paper that surface is made of a light transmitting material may be made to operate as the detection surface and the light source sections may be arranged at the rear surface side. Infrared LEDs may be employed for the light source sections and the camera sections may be provided with an infrared transmitting filter so that they may not be influenced by the back light of the display apparatus.

Now, a second embodiment of an optical position detecting device according to the present invention will be described. FIG. 2 is a schematic configuration view for illustrating the second embodiment of the optical position detecting device according to the present invention. In FIG. 2, the same reference numerals as those in FIG. 1 denotes the same parts as those in FIG. 1 and hence will not be described repeatedly.

While the light source sections of the first embodiment emit light to irradiate strip-shaped regions in the direction of the detection surface, a plurality of light source sections 10a emit light to irradiate fan-shaped regions as illustrated in FIG. 2. More specifically, the light source section 10a includes a cylindrical lens 11a and an LED 12. The cylindrical lens 11a is a plano-convex lens that has a cylinder-shaped refraction surface and the plane surface side of which lens is a diffusion surface. The cylindrical lens 11a refracts (diffuses) light from the LED 12a so as to make it spread into a fan shape in a horizontal direction and refracts (converges) light so as to make it become substantially parallel to the detection surface 1 in the vertical direction. In other words, the cylindrical lens 11a can irradiate a fan-shaped light beam in parallel with the detection surface 1 in the direction of the detection surface. The refraction surface and the curvature of the cylindrical lens 11a may be determined such that light is made to run along the direction of the detection surface and that the plurality of light source sections 10 can cover the entire surface of the detection surface. The plurality of LEDs 12a may be arranged on a straight line in the transversal direction and each of them may be arranged with a predetermined inclination so as to radially spread as illustrated in FIG. 2. The LEDs 12a may be arranged to show a fan-shape. The cylindrical lenses of the second embodiment may be made of resin for lenses like the beam forming lenses of the first embodiment.

In the illustrated example, the camera sections 20a respectively include ultra-wide angle lenses and image sensors and are arranged on the upper side of the detection surface 1. Each of the camera sections 20a has an angle of view that can image the entire surface of the detection surface and, for example, the horizontal angle of view may be equal or more than about 170 degrees.

The optical position detecting device of the second embodiment according to the present invention and having the above-described configuration controls the lighting operation of the light source sections 10a at the control section 40 like the first embodiment. In other words, the control section 40 turns on the plurality of light source sections 10a in a predetermined sequence at the time of the initial scan. Then, once the indicated position of the indicator body 2 is detected by the detection section 30, the control section 40 controls the light source sections so as to turn on at least one of the light source sections 10a that irradiates the range covering the indicated position of the indicator body 2 and turn off the remaining light source sections 10a. As a result, effects and advantages similar to those of the first embodiment can be obtained.

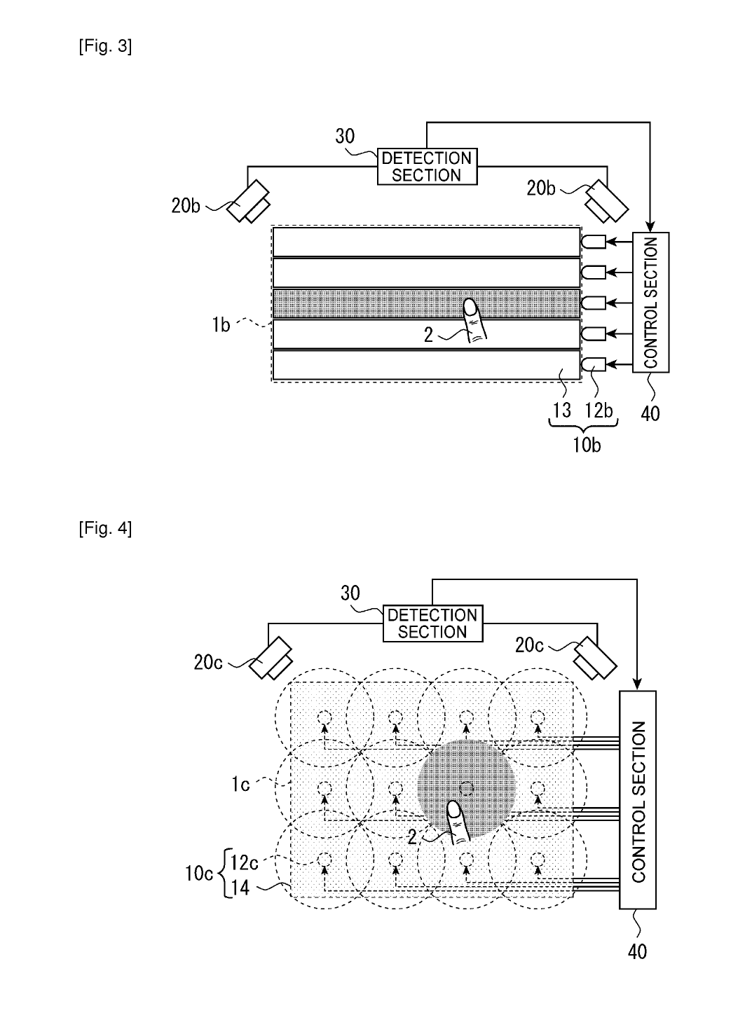

Now, a third embodiment of an optical position detecting device according to the present invention will be described. FIG. 3 is a schematic configuration view for illustrating the third embodiment of optical position detecting device according to the present invention. In FIG. 3, the same reference numerals as those in FIG. 1 denotes the same parts as those in FIG. 1 and hence will not be described repeatedly.

While lenses are employed for the light source sections of the first embodiment and those of the second embodiment, the third embodiment has an arrangement of guiding the light emitted from the light source sections to the detection surface using light guide plates. The detection surface 1b is made of a light transmitting material. For example, the detection surface 1b may be made of a light transmitting material such as glass or polycarbonate resin. The plurality of light source sections 10b include light guide plates 13 and LEDs 12b. The light guide plates 13 and the LEDs 12b are of the edge light type and arranged at the rear surface side of the detection surface 1b. In the illustrated example, the plurality of LEDs 12b are arranged at the right sides of the detection surface 1b so that the irradiation direction of light is directed toward the left side. A plurality of strip-shaped light guide plates that correspond to the LEDs 12b are arranged from left to right in the longitudinal direction. Light from the LED 12b enters from a side surface of the light guide plate 13 and repeatedly surface-reflected in the light guide plate 13 to irradiate the entire surface of the light guide plate 13. The entire surface of the detection surface can be selectively irradiated as a result of combining a plurality of light source sections 10b having such a configuration for use.

While light from the LEDs are turned into strip-shaped or fan-shaped beams by using the lenses in the first or second embodiment, whichever appropriate, strip-shaped beams of light are made to emit in the direction of the detection plate by using the light guide plates in the third embodiment. When fan-shaped light guide plates are employed instead of the strip-shaped light guide plates, fan-shaped light can be made to emit in the direction of the detection plate as in the case of the second embodiment.

The optical position detecting device of the third embodiment according to the present invention and having the above-described configuration controls the lighting operation of the light source sections 10b at the control section 40. In other words, the control section 40 turns on the plurality of light source sections 10b in a predetermined sequence at the time of the initial scan. Then, the camera sections 20b operate for imaging and, once the indicated position of the indicator body 2 is detected by the detection section 30, the control section 40 controls so as to turn on the light source section 10b that irradiates the range covering the indicated position of the indicator body 2 and turn off the remaining light source sections 10b. As a result, effects and advantages similar to those of the first embodiment and those of the second embodiment can be obtained.

Now, a fourth embodiment of an optical position detecting device according to the present invention will be described. FIG. 4 is a schematic configuration view for illustrating the fourth embodiment of the optical position detecting device according to the present invention. In FIG. 4, the same reference numerals as those in FIG. 1 denotes the same parts as those in FIG. 1 and hence will not be described repeatedly.

While the third embodiment has an arrangement using edge light type light sources, the fourth embodiment has an arrangement using directly under type light sources. Light emitted from the light source section is guided to the detection surface using diffusion plates. The detection surface 1c is made of a light transmitting material. For example, the detection surface 1c may be made of a light transmitting material such as glass or polycarbonate resin. The light source section 10c includes a diffusion plate 14 and a plurality of LEDs 12c. The light guide plates 14 and the LEDs 12c are of the directly under type and arranged at the rear surface side of the detection surface 1c. In the illustrated example, the plurality of LEDs 12c are arranged at predetermined intervals at the rear surface side of the detection surface 1c to form a matrix so as to make light enter the diffusion plate 14 from the rear surface side. As light from the LEDs 12c enters the diffusion plate 14, it is diffused by the diffusion plate 14 to irradiate a predetermined range. As beams of light from the plurality of LEDs 12c are combined and made to enter the diffusion plate 14, the entire surface of the detection surface can be selectively irradiated.

The optical position detecting device of the fourth embodiment according to the present invention and having the above-described configuration controls the lighting operation of the light source section 10c at the control section 40. In other words, the control section 40 turns on the plurality of LEDs 12c in a predetermined sequence at the time of the initial scan. Then, the camera sections 20c operates for imaging and, once the indicated position of the indicator body 2 is detected by the detection section 30, the control section 40 controls so as to turn on the LED 12c that irradiates the range covering the indicated position of the indicator body 2 and turn off the remaining LEDs 12c. As a result, effects and advantages similar to those of the first embodiment and those of the third embodiment can be obtained.

While a direct image of the indicator body irradiated by the light source section is imaged by the camera sections in the fourth embodiment, the present invention is not limited to this but the camera sections may be arranged at positions separated from the detection surface in a vertical direction relative to the front surface side of the detection surface so as to image the indicator body by the camera section, using the back light of the immediate under type or the edge light type as background.

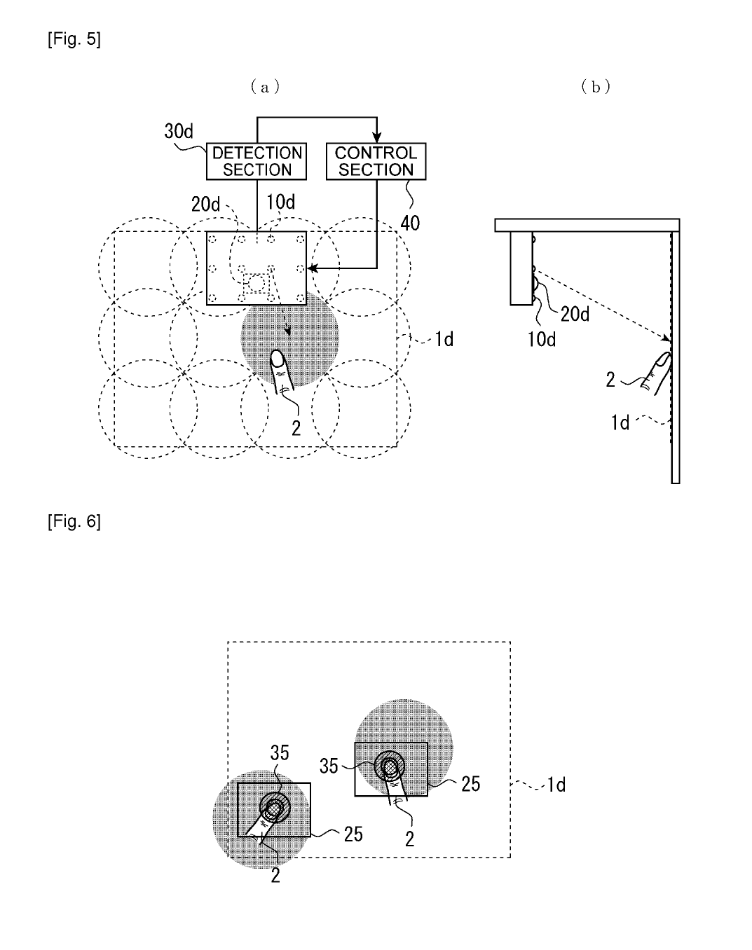

Now, a fifth embodiment of an optical position detecting device according to the present invention will be described. FIG. 5 is a schematic configuration view for illustrating the fifth embodiment of the optical position detecting device according to the present invention. FIG. 5(a) is a front view and FIG. 5(b) is a side view. In FIG. 5, the same reference numerals as those in FIG. 1 denotes the same parts as those in FIG. 1 and hence will not be described repeatedly.

The fifth embodiment is designed to detect the indicated position of the indicator body from a position separated from the detection surface relative to the front surface side. As illustrated, a plurality of light source sections 10d and a camera section 20d are arranged at positions separated from the detection surface 1d in the vertical direction relative to the detection surface 1d. The detection surface 1d is, for example, a wall surface or the like in a room and the light source sections 10d and the camera section 20d are suspended from the ceiling surface. The plurality of light source sections 10d are arranged in such a way that they may be combined so as to be able to selectively irradiate the entire surface of the detection surface from positions separated relative to the detection surface 1d in the vertical direction. In other words, the light source sections 10d are so arranged that a plurality of LEDs may be combined to irradiate the entire surface of the detection surface thoroughly such that, for example, an upper right part of the detection surface may be irradiated by the LED arranged at an upper right position and a lower right part of the detection surface may be irradiated by the LED arranged at a lower right position. The light source sections 10d irradiate the detection surface 1d from positions separated relative to the detection surface 1d in the vertical direction and, therefore, when the light source sections 10d emit light to irradiate circular-shaped regions in the direction of the detection surface, the direction of irradiation of each LED may be so adjusted that the region of irradiation partly overlaps adjacent regions of irradiation so as to irradiate the detection surface thoroughly. Alternatively, the light source sections 10d may emit light to irradiate square-shaped regions.

The fifth embodiment has a single camera section 20d. While the camera sections of the first embodiment and so on can operate for detection in a direction parallel to the detection surface, the camera section 20d of the fifth embodiment images the entire surface of the detection surface from a position separated relative to the detection surface 1d in the vertical direction at the surface side of the detection surface 1d. In other words, the camera section 20d images the indicator body 2, viewing it from above.

Since the fifth embodiment has only a single camera section 20d and images an indicator body 2 from above, the indicated position of the indicator body 2 can be detected as the position where the image of the indicator body 2 exists in the imaged picture. Therefore, the detection section 30d of the fifth embodiment does not perform any arithmetic operations on the basis of the principle of triangulation.

The optical position detecting device of the fifth embodiment according to the present invention and having the above-described configuration controls the lighting operation of the light source sections 10b at the control section 40. In other words, the control section 40 turns on the plurality of light source sections 10d in a predetermined sequence at the time of the initial scan. Then, the camera sections 20d operates for imaging and, once the indicated position of the indicator body 2 is detected by the detection section 30, the control section 40 controls so as to turn on the light source section 10d that irradiates the range covering the indicated position of the indicator body 2 and turn off or reduce the power of the remaining light source sections 10d. As a result, effects and advantages similar to those of the first to fourth embodiments can be obtained.

The camera section 20d may have a windowing function. A windowing function will be described by referring to FIG. 6. FIG. 6 is a schematic plan view for illustrating the window function of the camera section of an optical position detecting device according to the present invention. Note that the configurations of the light source sections and the camera section and so on are basically the same as those of the fifth embodiment and hence not illustrated.

The optical position detecting device according to the present invention selectively irradiates part of the detection surface by the light source sections and hence the camera section preferably has a windowing function capable of imaging only the region of a window defined to the irradiated part. The camera section images a region of the window 25 that is defined at an arbitrary place with an arbitrary size in an imageable angle of view. It is sufficient that the window 25 is defined so as to overlap the range irradiated by the light source sections (the shaded part in FIG. 6). Additionally, it is sufficient that the detection section detects an image of the indicator body 2 by applying a separability filter 35 to the image information of the window 25 that is imaged if necessary. Owing to the windowing function, the camera section images a region narrower than the entire field of view of the camera section so that the data capacity of the image is reduced to raise the imaging speed of the camera section and also the processing speed of the detection section. Then, the indicated position of the indicator body moving at high speed can be detected with high response.

An optical position detecting device according to the present invention is applicable to multi-touch. In other words, optical position detecting device can detect a plurality of indicator bodies. For example, when the optical position detecting device detects the plurality of indicator bodies using the camera section having a windowing function, it is sufficient that the optical position detecting device switches the position of the window 25 also switches the position of the LED of the light source section to be turned on. Furthermore, it is possible to select the plurality of LEDs of the light source sections by the control section and detect the indicated positions of the plurality of indicator bodies by a single imaging operation, using the camera section having a multi-windowing function capable of imaging a plurality of windows simultaneously.

The camera section having the windowing function can be applied not only to the fifth embodiment but also to the position detecting device of any of the first to fourth embodiments having two camera sections. The optical position detecting device of any of the first to fourth embodiments can operate for detection at high speed using the windowing function of imaging only the regions irradiated by the light source sections.

While a plurality of light source sections are arranged at the position separated from the detection surface in a vertical direction relative to the front surface side of the detection surface in the fifth embodiment, the present invention is not limited to this but the light source sections may alternatively be arranged at a position separated from the detection surface in a vertical direction relative to the rear surface side of the detection surface if the detection surface transmits light. In this case, the camera section may be arranged at the front surface side to operate for imaging from the front side or the camera section may operate for imaging from the rear side.

An optical position detecting device according to the present invention not limited to the illustrated embodiments, which may be subjected to various alterations without departing from the scope of the present invention. For example, the combination of one or more than one light source sections and one or more than one camera sections is replaceable in the embodiments and the embodiments provide similar effects and advantages after such a replacement.

### EXPLANATION OF REFERENCE SYMBOLS

1: Detection surface
2: Indicator body
10: Light source section
11: Beam forming lens
11a: Cylindrical lens
13: Light guide plate
14: Diffusion plate
20: Camera section
25: Window
30: Detection section
35: Separability filter
40: Control section

1. An optical position detecting device capable of detecting an indicated position of an indicator body input onto a detection surface, the optical position detecting device comprising:
a plurality of light source sections each for emitting light to irradiate a predetermined region of the detection surface so as to be able to selectively irradiate the entire surface of the detection surface by combination thereof;
a camera section having an angle of view capable of imaging the entire surface of the detection surface, and imaging an image of the indicator body irradiated by the light source sections;
a detection section for calculating an indicated position of the indicator body by using the image of the indicator body imaged by the camera section; and
a control section adapted to turn on the plurality of light source sections simultaneously or in a predetermined sequence at time of initial scan and, once the indicated position of the indicator body is detected by the detection section, turning on at least one of the light source sections irradiating a range covering the indicated position of the indicator body detected but turning off or reducing power for lighting all the remaining light source sections.

2. The optical position detecting device according to claim 1, in which each of the plurality of light source sections emits light for irradiating a strip-shaped region in the direction to the detection surface.

3. The optical position detecting device according to claim 1, in which each of the plurality of light source sections emits light for irradiating a fan-shaped region in the direction to the detection surface.

4. The optical position detecting device according to claim 1, in which each of the plurality of light source sections emits light for irradiating a square-shaped region in the direction to the detection surface.

5. The optical position detecting device according to claim 1, in which each of the plurality of light source sections emits light for irradiating a circle-shaped region in the direction to the detection surface.

6. The optical position detecting device according to claim 2, in which each of the plurality of light source sections has a beam forming lens and an LED.

7. The optical position detecting device according to claim 3, in which each of the plurality of light source sections has a cylindrical lens and an LED.

8. The optical position detecting device according to claim 1, in which the detection surface transmits light and each of the plurality of light source sections has a light guide plate arranged at a rear surface side of the detection surface and an LED.

9. The optical position detecting device according to claim 1, in which the detection surface transmits light and the plurality of light source sections have a diffusion plate arranged at a rear surface side of the detection surface and a plurality of LEDs.

10. The optical position detecting device according to claim 1, in which each of the plurality of light source sections is arranged at a position separated from the detection surface in a vertical direction relative to a front surface side of the detection surface.

11. The optical position detecting device according to claim 1, in which the detection surface transmits light and each of the plurality of light source sections is arranged at a position separated from the detection surface in a vertical direction relative to a rear surface side of the detection surface.

12. The optical position detecting device according to claim 1, in which each of the plurality of light source sections has an infrared LED and the camera section has an infrared transmitting filter.

13. The optical position detecting device according to claim 1, in which the control section controls so as to make the irradiation power of each of the light source sections irradiating a range covering the indicated position of the indicator body stronger than the irradiation power of each of the light source sections when turning on the light source sections simultaneously or in a predetermined sequence at the time of the initial scan.

14. The optical position detecting device according to claim 1, in which the camera section images the entire surface of the detection surface from a position separated from the detection surface in a vertical direction relative to a front surface side of the detection surface.

15. The optical position detecting device according to claim 1, in which the detection surface transmits light and the camera section images the entire surface of the detection surface from a position separated from the detection surface in a vertical direction relative to a rear surface side of the detection surface.

16. The optical position detecting device according to claim 1, in which the camera section has a windowing function of imaging the region of a window defined at an arbitrary place to an arbitrary size in the angle of view capable of imaging.

17. The optical position detecting device according to claim 1, in which the detection section detects an image of the indicator body by using a separability filter.

18. The optical position detecting device according to claim 1, which further comprises a display device, a display surface of the display device being the detection surface.

19. The optical position detecting device according to claim 18, in which the display surface of the display device is made of a light transmitting material and the light source sections is arranged at a rear surface side of the display surface.
